(19) United States
(12) Patent Application Publication
(10) Pub. No.: US 2007/0050292 A1
(43) Pub. Date: Mar. 1, 2007

(54) System and method for consumer opt-out of payment conversions

(76) Inventor: Phillip C. Yarbrough, Dallas, TX (US)

Correspondence Address: FISH & RICHARDSON P.C., P.O. BOX 1022, MINNEAPOLIS, MN, 55440-1022, US

(21) Appl. No.: 11/211,012

(22) Filed: Aug. 24, 2005

(51) Int. Cl. G06Q 40/00

(52) U.S. Cl. 705/45

(57) ABSTRACT

In one embodiment, for example, software for consumer opt-out of payment conversions comprises computer readable instructions operable to identify check data of a physical check at a receiving entity. The software is further operable to compare the identified check data to an opt-out list to determine a match, with the opt-out list comprising a plurality of consumer records and at least a subset of the consumer records provided by an opt-out list provider. The software then, in response to the identified check data not being matched to the opt-out list, authorizes the check for conversion to an electronic payment transaction or, in response to the identified check data being a match to the opt-out list, indicates that the check should be processed by a financial institution without electronic payment conversion.

### TECHNICAL FIELD

This invention relates to check or other payment processing and, more specifically, to a method and system for consumer opt-out of payment conversions.

### BACKGROUND

Today, consumers (whether individuals, organizations, businesses, or other entities) mail-in or otherwise present physical checks to a point-of-sale (or point-of-purchase) to pay utility bills, mortgage payments, car payments, credit card payments, utility bills, insurance premiums, groceries, etc. Typically, the point-of-sale receives the check, processes the check using any suitable technique, and then communicates the physical check to a recipient bank (or bank of first deposit) for deposit or forwarding to the appropriate account holder. But in certain situations, the point-of-sale processes these payments in lockboxes all over the country or world and converts the payments to an Automated Clearing House (ACH) transaction for collection. For example, Accounts Receivable Conversion (ARC) is a service that allows consumer check payments sent to a lockbox or drop box location to be converted into an ACH electronic debit using an ACH network.

The ACH network is a highly reliable and efficient nationwide batch-oriented electronic funds transfer system that provide for the inter-bank clearing of electronic payments for participating depository financial institutions. In the United states, the Federal Reserve and Electronic Payments Network act as ACH Operators. They are central clearing facilities through which financial institutions transmit or receive ACH entries. Such ACH entries may include, for example: i) direct Deposit of payroll, Social Security and other government benefits, and tax refunds; ii) direct Payment of consumer bills such as mortgages, loans, utility bills, insurance premiums and others; iii) business-to-business payments; iv) electronic checks; v) e-commerce payments; and vi) federal, state and local tax payments.

In other situations, the bank of first deposit receives a physical check from the receiving entity (or point-of-sale), processes the check using any suitable technique, and then communicates the physical check to the recipient (or payor) bank for storage or forwarding to the appropriate account holder. For example, the checks are typically sorted according to payor bank, bundled together, and physically shipped to the receiving bank. This physical handling of checks and other commercial paper transactions requires large amount of labor, costs, and storage space and is subject to various threats. But the Check Clearing for the 21st Century Act, commonly referred to as “Check 21,” federally mandates that recipient banks must now accept electronic images of checks from other banks or entities, thereby reducing costs and physical threats and increasing efficiency. Each electronic image may then be printed to generate an image replacement document, which is the legal equivalent of a physical check.

### SUMMARY

This disclosure provides a system and method for consumer opt-out of payment conversions. In one embodiment, for example, software comprises computer readable instructions operable to identify check data of a physical check at a receiving entity. The software is further operable to compare the identified check data to an opt-out list to determine a match, with the opt-out list comprising a plurality of consumer records and at least a subset of the consumer records provided by an opt-out list provider. The software then, in response to the identified check data not being matched to the opt-out list, authorizes the check for conversion to an electronic payment transaction or, in response to the identified check data being a match to the opt-out list, indicates that the check should be processed by a financial institution without electronic payment conversion.

In another embodiment, a method (often computer implemented) for updating a consumer opt-out list of payment conversions comprises receiving a request to update a consumer opt-out list from a particular remote consumer via a network, with the consumer opt-out list comprising a plurality of consumer records. An opt-out GUI is presented to the particular consumer and information is received to generate a new consumer record via the GUI, with the information comprising at least a financial institution identifier and an account identifier. The consumer opt-out list is then updated with the new consumer record based on the received information.

The details of one or more embodiments of the invention are set forth in the accompanying drawings and the description below. One or more embodiments of the invention may include several important technical advantages. For example, the disclosure may allow a receiving entity (or other consumer level organization) to easily and efficiently process checks while still allowing consumers to opt-out of electronic processing. In another example, the present disclosure provides the consumer with the ability to simply or remotely opt-out of having his payments converted into electronic transactions. Moreover, this may allow the consumer to opt-out across organizations without requiring the consumer to repeatedly opt-out at each individual store or organization. In yet another example, an opt-out list provider may, via subscription, provide any lockbox operator or merchant with the ability download the opt-out list on a regular basis to sort or identify those items that are not to be converted. Further, the opt-out list provider may manage a national opt-out list, which will let consumers go to one place, either by phone or via the internet (for example), to request that none of their checks be converted to an ACH transaction. Yet a further advantage may be that such merchants may not be required to train cashiers or other employees in the opt-out process, which would save both time and money. Of course, various embodiments of the invention may have none, some or all of these advantages. Other features, objects, and advantages of the invention will be apparent from the description and drawings, as well as from the claims.

### DESCRIPTION OF DRAWINGS

FIG. 1 illustrates an example system for consumer opt-out of payment conversions in accordance with one embodiment of the present disclosure;

FIG. 2 illustrates an example opt-out list as used by the system of FIG. 1;

FIG. 3 illustrates an example graphical user interface (GUI) as implemented within the system of FIG. 1;

FIG. 4 is a flowchart illustrating an example method for processing a conversion opt-out from a consumer in accordance with one embodiment of the present disclosure; and

FIG. 5 is a flowchart illustrating an example method for processing checks using the opt-out list in accordance with one embodiment of the present disclosure.

### DETAILED DESCRIPTION

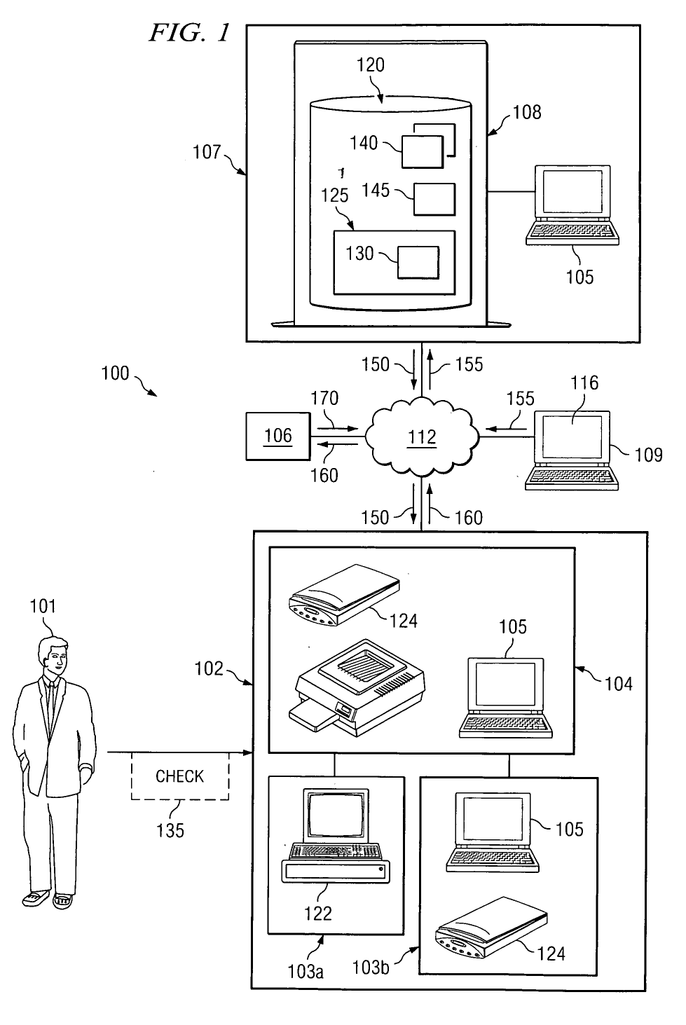

FIG. 1 illustrates a system 100 for consumer opt-out of payment conversions in accordance with one embodiment of the present disclosure. Generally, system 100 includes at least a portion of any retail, financial, or banking system operable to receive payments, checks or commercial paper, or other similar transactions (described herein as checks 135) from consumers, while allowing these consumers to quickly and easily opt-out of having their respective checks 135 converted into an electronic form, such as ACH, prior to such payments. Consumers may have many reasons for desiring, requesting, or otherwise implementing “opt-out”. For example, the consumer may be paying his bank or financial institution to return all checks 135 that are presented for payment so there will be hard copy proof of payment. Often, if a consumer's check is converted in the ARC process, the check information is truncated and the consumer's demand deposit account (DDA) account is debited as though the transaction were an ATM or debit transaction. In addition, the consumer may not be getting his checks returned, but instead is getting an image statement from the bank either online and/or through the mail. When an item is converted in the ARC process, no image of the item is sent to the consumer's bank, so he does not usually receive the desired image as proof of purchase.

Turning to the illustrated embodiment, system 100 is typically distributed into at least one receiving entity (or point-of-sale) 102 and at least consumer 101, which may be an individual, business, organization or any other entity with an associated payment account, such as a checking account. Often, system 100 is electronically inter-coupled, thereby allowing efficient communications among the various components. But system 100 may be a standalone processing environment, such as system 100 consisting of one consumer level receiving entity 102 and/or one financial institution 106 with a plurality of interconnected offices, or any other suitable retail environment operable to dynamically generate and communicate electronic deposits to appropriate financial institutions 106.

As illustrated, system 100 also includes one or more receiving entities 102. Receiving entity 102 is any organization or person, including a corporation, a privately owned store, lockbox operator, an online vendor, a traveling salesman, a telephony system, outside representative or agent, a local or remote automated teller machine (ATM), or other original recipient, point-of-sale, or location operable to receive physical checks 135 or other commercial paper transactions. Receiving entity 102 may also represent a teller at one of the financial institutions 106 without departing from the scope of the disclosure. Receiving entity 102 may also be operable to generate an Automated Clearing House (ACH) transaction 170 based on the checking transaction for quickly processing the transaction with financial institutions 106. Regardless, at any appropriate time and using any suitable automatic or manual technique, receiving entity 102 is operable to quickly identify checks 135 that are subject to consumer opt-out based on at least a portion of opt-out list 140 or a local copy thereof. In the illustrated embodiment, receiving entity 102 includes two stores, 103a and 103b respectively, and a service center 104. But it will be understood that receiving entity 102 may include none, one, or both (as well as other) components without departing from the scope of this disclosure. In other words, a receiving entity 102 that is an automated teller machine (ATM) may be considered a merged point-of-receipt 103 and service center 104 and reference to point-of-receipt 103 and service center 104 is meant to include a singular or standalone receiving entity 102 where appropriate.

Point-of-receipt 103 is any person or entity that receives physical checks 135. For example, point-of-receipt 103 may be a store, a route driver, a mail box, and others. In certain embodiments, point-of-receipt 103 may be operable generate electronic check images and communicate encrypted or unencrypted electronic check images to a service center 104. Illustrated first point-of-receipt 103a includes an electronic cash register (ECR) 122 for receiving and storing physical checks 135. ECR 122 may be operable to generate electronic check images from scanned physical checks 135 upon receipt. Of course, receiving entity 102 may include other additional or alternative components for processing transactions. For example, illustrated receiving entity 102 includes second point-of-receipt 103b that includes a scanner 124 and a computer 105 for processing a check 135 or electronic payment. Computer 105 may include any computing device operable to present information to a user at point-of-receipt 103. For example, computer 105 may allow the user to log-on to opt-out management engine 130, monitor a communication of images, and communicate the images via an included or referenced file transfer program such as Secure FTP. While not illustrated, computer 105 (as well as ECR 122 or scanner 124) may also include, execute, or present a portion or a version of opt-out management engine 130 (illustrated in server 108) for performing or implementing opt-out or other check processing without departing from the scope of the disclosure. For example, a local opt-out management engine 130 may dynamically collect or otherwise identify electronic check images, which are not subject to consumer opt-out, for communication to service center 104 or depositing to financial institution 106.

Scanner 124 is any suitable device operable to capture or otherwise obtain information from the received physical transactions, such as the checks from receiving entity 102. For example, scanner 124 may be a scanner, a sorter, an image capture device, or any other similar device (or combination thereof) including a digital camera for recording or generating electronic images of the checks and/or a MICR reader for capturing (Magnetic Ink Character Recognition) MICR data from the checks. The example digital camera may record an electronic check image of the front and back of each check in black and white, grayscale, and/or color. As used herein, electronic check image may be a digital image or file of the check including the front, the back, both, or any suitable portion thereof. This check image may be in any suitable format including Moving Picture Experts Group (MPEG), Joint Photographic Experts Group (JPEG), Tag Image File Format (TIFF), including any suitable version thereof (such as TIFF 6.0), and others. The MICR reader may capture or generate the MICR code in any appropriate format including E13-B, CMC-7, as well as others. The MICR code typically includes a plurality of fields including routing/transit field, account field, serial field, and others.

Example service center 104 is any back office, agent, department, data processing center, or other entity or computer operable to provide centralized or managed processing of checks 135 from a plurality of points-of-receipt 103. For example, service center 104 may be a corporate headquarters, a regional management office, a designated point-of-receipt 103, as well as others. Indeed, service center 104 may be unaffiliated with point-of-receipt 103, such as comprising an outsourced data processing organization, without departing from the scope of the disclosure. Moreover, any or all points-of-receipt 103 may act or be operable to perform as service center 104. Illustrated service center 104 includes a printer, scanner 124, and administration or workstation computer 105 to process opt-out list 140 from opt-out list provider 107, but it will be understood that service center 104 may include none, some, as well as other components without departing from the scope of this disclosure.

Opt-out list provider 107 is any intra-company, local, regional, or substantially nationwide or nationwide electronic storage facility, data processing center, web site, or subscription-based company that allows for one or a plurality of consumers 101 to easily enter, present, or otherwise communicate enough information to allow receiving entities 102 to dynamically determine if the consumer's checks 135 are subject to opt-out processing or procedures. For example, opt-out list provider 107 may be a central database communicably coupled with receiving entities 102 and financial institutions 106. Further, opt-out list provider 107 list may provide opt-out list 140 on a subscription basis, often for a fee, to organizations or other entities 102 that perform ARC or other electronic payment conversion. The subscribers would typically have to sign, whether physically or electronically, confidentiality agreements before they were allowed to access the secure site to download the opt-out list's account numbers or consumer records.

Opt-out list provider 107 may be physically or logically located at any appropriate location including in one of the receiving entities 102 or off-shore, so long as it remains operable to store information associated with a plurality of consumers 101, such as in illustrated opt-out list 140, in example server 108. Of course, opt-out list provider 107 may not use illustrated server 108 to store opt-out list 140, but may instead use other local components or remote data centers (not illustrated).

Illustrated server 108 includes memory 120 and processor 125 and comprises an electronic computing device operable to receive, transmit, process, and store data associated with system 100 and, more specifically, consumers 101. For example, server 108 may be any computer or processing device such as a blade server, general purpose personal computer (PC), Macintosh, workstation, a mainframe, or any other suitable device. Generally, FIG. 1 provides merely one example of servers or computers that may be used with the disclosure. For example, although FIG. 1 illustrates one server 108 that may be used with the disclosure, system 100 can be implemented using computers other than servers, as well as a server pool. In other words, the present disclosure contemplates computers other than general purpose computers as well as computers without conventional operating systems. As used in this document, the term “computer” is intended to encompass a personal computer, workstation, network computer, or any other suitable processing device. As described herein, server 108 may be adapted to execute any operating system including Linux, UNIX, Windows Server, or any other suitable operating system. According to one embodiment, server 108 may also include or be communicably coupled with a web server and/or a secure server.

Memory 120 may include any memory or database module and may take the form of volatile or non-volatile memory including, without limitation, magnetic media, optical media, random access memory (RAM), read-only memory (ROM), removable media, or any other suitable local or remote memory component. In the illustrated embodiment, memory 120 includes one or more opt-out lists 140 and history or audit log 145, but memory 120 may include any appropriate data such as account information, administration profiles, MICR codes, subscriber database, billing information, an all-items file, and others.

Opt-out list 140 includes any parameters, variables, fields, algorithms, rules, and other data for allowing financial institutions 106 or receiving entities 102 to identify checks 135 associated with consumers 101 that have opted out of payment conversion processing. For example, opt-out list 140 typically stores a plurality of consumer records, with each record including at least a consumer identifier associated with a one of a plurality of consumers 101. In one embodiment, opt-out list 140 may comprise one or more tables stored in a relational database described in terms of SQL statements or scripts. In this and other similar embodiments, each consumer record may be associated with a particular DDA or other consumer payment account, with the client identifier comprising the primary key. The primary key allows for quick access and location and helps ensure that duplicates are not completely processed. In another embodiment, opt-out list 140 may store or define various data structures as text files, extensible Markup Language (XML) documents, Virtual Storage Access Method (VSAM) files, flat files, Btrieve files, comma-separated-value (CSV) files, internal variables, or one or more libraries. In short, opt-out list 140 may comprise one table or file or a plurality of tables or files stored on one computer or across a plurality of computers in any appropriate format. Moreover, opt-out list 140 may be local or remote to opt-out list provider 107 without departing from the scope of this disclosure and store any type of appropriate data. Audit log 145 allows opt-out list provider 107 to track various information associated with opt-out processing, including user actions, account numbers, IP addresses, and other such security or audit information for tracking or reporting purposes. As with opt-out list 140, audit log 145 may be in any appropriate format or structure.

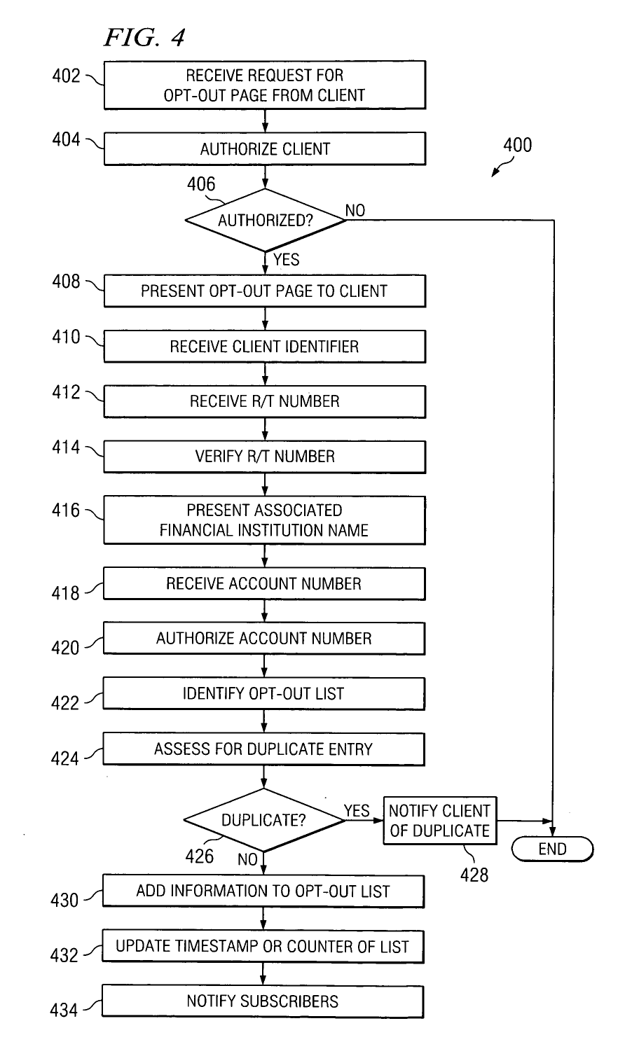

Server 108 also includes processor 125. Processor 125 executes instructions and manipulates data to perform the operations of server 108 such as, for example, a central processing unit (CPU), a blade, an application specific integrated circuit (ASIC), or a field-programmable gate array (FPGA). Although FIG. 1 illustrates a single processor 125 in server 108, multiple processors 125 may be used according to particular needs and reference to processor 125 is meant to include multiple processors 125 where applicable. In the illustrated embodiment, processor 125 executes opt-out management engine 130, which performs or executes various check processes such as, for example, techniques described in FIG. 4.

Opt-out management engine 130 is any software component operable to, among other things, interact with local or remote consumers 101 to identify information for opt-out list 140 and automatically generate update files 150, whether incremental or full updates, for subscribers to dynamically keep local opt-out lists relatively up-to-date. As used herein, software generally includes any appropriate combination of software, firmware, wired or programmed hardware, and/or other logic. For example, opt-out management engine 130 may be written or described in any appropriate computer language including C, C++, Java, Perl, Visual Basic, assembler, any suitable version of 4GL, and others or any combination thereof. It will be understood that while opt-out management engine 130 is illustrated in FIG. 1 as a single multi-tasked module, the features and functionality performed by this engine may be performed by multiple modules such as, for example, a GUI or display module, a subscriber interface module, an update management/distribution module, and an administration module. Further, while illustrated as internal to server 108, one or more processes associated with opt-out management engine 130 may be stored, referenced, accessed, or executed remotely (such as through receiving entity 102 or client 109). Moreover, opt-out management engine 130 may be a child or sub-module of another software module (not illustrated) without departing from the scope of this disclosure.

In one embodiment, opt-out management engine 130 may be communicably coupled with a client 109 via graphical user interface (GUI) 116. Client 109 is any local or remote computing device operable to receive requests from consumer 101 via a GUI 116, a CLI (Command Line Interface), or other user interface. At a high level, each client 109 includes at least GUI 116 and comprises an electronic computing device operable to receive, transmit, process and store any appropriate data associated with system 100 including providing opt-out information to server 108. It will be understood that there may be any number of clients 104 communicably coupled to system 100. Further, “client 109,” “consumer 101,” and “user” may be used interchangeably as appropriate without departing from the scope of this disclosure. Moreover, for ease of illustration, each client 109 is described in terms of being used by one user or consumer. But this disclosure contemplates that many users may use one computer or that one user may use multiple computers to submit or review opt-out information via GUI 116. As used in this disclosure, client 109 is intended to encompass a personal computer, touch screen terminal, workstation, network computer, kiosk, wireless data port, wireless or wireline phone, personal data assistant (PDA), one or more processors within these or other devices, or any other suitable processing device. For example, client 109 may comprise a computer that includes an input device, such as a keypad, touch screen, mouse, or other device that can accept information, and an output device that conveys information associated with the operation of server 102 or clients 104, including digital data, visual information, or GUI 116. Both the input device and output device may include fixed or removable storage media such as a magnetic computer disk, CD-ROM, or other suitable media to both receive input from and provide output to users of clients 104 through the display, namely GUI 116.

GUI 116 comprises a graphical user interface operable to allow the user of the workstation to interface with at least a portion of system 100 for any suitable purpose. Generally, GUI 116 provides the user of the workstation with an efficient and user-friendly presentation of data provided by or communicated within system 100. GUI 116 may comprise a plurality of customizable frames or views having interactive fields, pull-down lists, and buttons operated by the user. In one embodiment, GUI 116 presents interfaces that allow entry of opt-out information and associated buttons and receives commands from the user via one of the input devices. For example, GUI 116 may allow a user to enter opt-out information into a database, search or query associated consumer records, view subscriber reports, and other similar or suitable tasks. Moreover, it should be understood that the term graphical user interface may be used in the singular or in the plural to describe one or more graphical user interfaces and each of the displays of a particular graphical user interface. Therefore, GUI 116 contemplates any graphical user interface, such as a generic web browser or touch screen, that processes information in system 100 and efficiently presents the results to the user. Server 108 can accept data from the workstation via the web browser (e.g., Microsoft Internet Explorer or Netscape Navigator) and return the appropriate HTML or XML responses using network 112.

Server 108 may also include interface 117 for communicating with other computer systems or components, such as another server 108 or receiving entity 102, over network 112 in a client-server or other distributed environment. In certain embodiments, server 108 receives electronic images of checks from internal or external senders through interface 117 for storage in memory 120 and/or processing by processor 125. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals.

Network 112 facilitates wireless or wireline communication between computer servers 108 and any other local or remote computer or component, such as all or a portion of a bank posting systems or other intermediate systems. For example, illustrated network 112 may be a network internal to an enterprise, a virtual private network (VPN), or other local network. But, while illustrated as one continuous network 112, network 112 may be a plurality of networks or subnets without departing from the scope of this disclosure, so long as at least portion of network 112 may facilitate communications between the requisite parties or components. In other words, network 112 encompasses any internal or external network, networks, sub-network, or combination thereof operable to facilitate communications between various computing components in system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations.

System 100 may also include one or more financial institutions 106. Generally, financial institution 106 is any agent, third-party resource, clearing house, branch, processing center, or central office of a bank or other similar financial institution. Indeed, while illustrated as one bank, any number of banks and/or other institutions 106 may be included in or coupled to system 100 without departing from the scope of this disclosure. Moreover, two or more financial institutions 106 may represent two or more routing/transit numbers associated with one bank.

In one aspect of operation of one embodiment, point-of-receipt or store 103 receives one or more physical checks 135 from consumers 101. For example, point-of-receipt 103 may receive check 135 via a cash register 122, the mail or other delivery service, or via any other suitable appropriate component or technique. Consumer 101 may then orally notify receiving entity of his desire to opt out from electronic payment conversion. In this case, the employee at store 103 may request certain information from consumer 101 and generate a local opt-out consumer record, sometimes using ECR 122, which may then be synchronized with opt-out list provider 107. In another embodiment, consumer 101 may use a computer 105 or keypad to input his opt out information into system 100 at the point of payment, namely store 103.

Point-of-receipt 103 may automatically generate electronic check images based on the received checks 135. The electronic check images may be generated by electronic cash register 122, scanner 124, a camera in an ATM, and any other local or remote capturing devices. Moreover, it will be understood that point-of-receipt 103 may not generate some or all electronic check images, but may instead deliver or transport physical checks 135 to service center 104 without departing from the scope of the disclosure. Once the appropriate electronic check images have been generated or identified, point-of-receipt 103 collects the electronic check images into a store file. It will be understood that such a store file may be in any appropriate format including fixed record format, CSV file format, X9.37 DSTU 2003, and other suitable formats. Indeed, point-of-receipt 103 may encrypt store files for additional security. Then, point-of-receipt 103 may communicate the store file to service center 104 at any appropriate time. For example, point-of-receipt 103 may communicate the store file according to a predetermined schedule, dynamically based on a number of checks, or upon request from service center 104.

Once service center 104 receives the store file and any physical checks, it begins comparing the checks 135 to a local opt-out list, normally kept up-to-date via subscriptions or synchronizations with opt-out list provider 107. If receiving entity 107 determines that one of the checks 135 matches a consumer record in the opt-out list, then that particular check is logically or physically set aside and processed without conversion to electronic payment or other back office conversion. Such processing may include physically depositing the check with financial institution 106, generating a substitute check (or IRD), or other similar processing. Regardless, due to the consumer's desire to opt-out, receiving entity 102 does not prepare for or perform electronic conversion of the particular check 135.

But if the particular check does not match the local opt-out list or distributed opt-out list 140, then receiving entity 102 may use scanner 124 or another reading device to capture at least a portion of the MICR data of check 135. Of course, when desired or required, receiving entity may also manually key in the amount of the transaction or other requisite information. For example, one portion of the captured MICR data may include routing number, account number, and serial number, as well as payee or consumer information and the check amount. In this case, the receiving entity 102 transmits this information to financial institution 106, which then enters the transaction into the ACH Network upon receiving the check information. The transaction is then processed through the ACH network. In certain cases, receiving entity 102 may then destroy the original check 135 within fourteen days of the settlement date of the entry and retain a reproducible, legible, image, microfilm, or copy of the front of the check 135 for two years from the settlement date of the ARC entry.

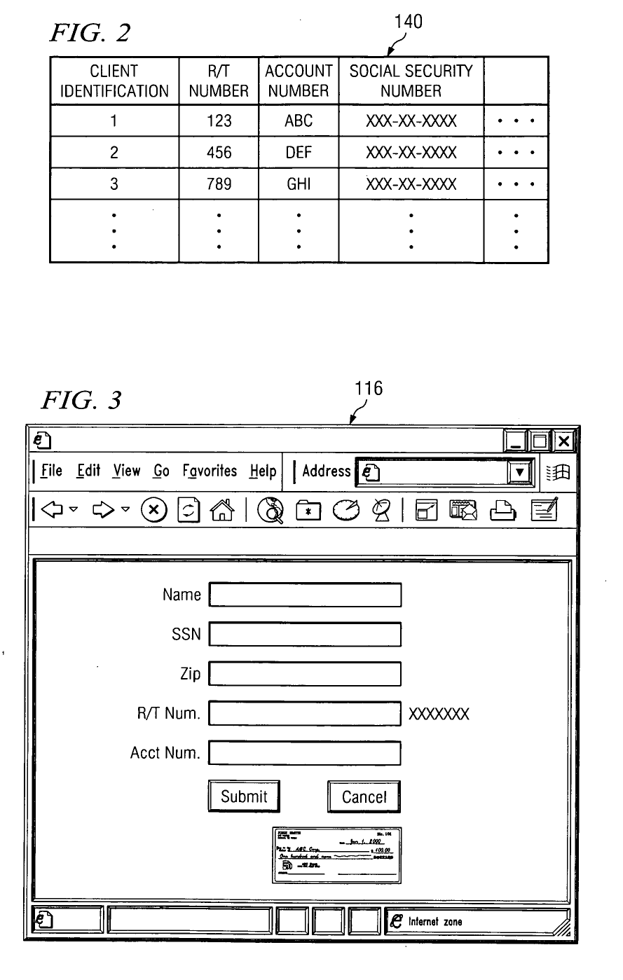

FIG. 2 illustrates an example opt-out list 140 as used by system 100. In general, system 100 uses opt-out list 140 to store and process electronic records or data structures of consumer opt-outs. As described above, opt-out list 140 may be stored, referenced, or processed in any appropriate format. But, for example purposes, illustrated opt-out list 140 is a multi-dimensional data structure that includes one or more consumer records, which include multiple columns or data fields. In this example, each consumer record includes a consumer name or other identifier (such as SSN), a routing/transit number, and an account number. It will be understood that each consumer record may include none, some, or all of the example columns. In one embodiment, the consumer record may include a static or dynamic link to another table: for example, the routing/transit number may be used to access particular entries of a valid financial institution list, thereby allowing easy verification of an input routing/transit number. It should be noted that the consumer record may be accessed by client name, record identifier, or any other field or combination thereof (such as the routing/transit number and the account number).

FIG. 3 illustrates an example graphical user interface (GUI) or display 116 as implemented within system 100. Generally, this display 116 presents input fields for consumer 101 or client 109 to opt-out of payment conversions. Opt-out management engine 130 then takes these fields and generates a consumer record for master opt-out list 140. Accordingly, display 116 includes a field for client identifier, routing/transit number, account number, and any other informational or required data. Moreover, display 116 may include other informative elements such as instructions, contact information, or an example check graphic to help consumer 101 locate certain information. For example, when consumer 101 enters his account number(s) into the listing, he might be advised that the listing is distributed every 30 or 90 days and the merchants and lockboxes would be advised of their account number(s) at that time. Moreover, the consumer 101 may be advised of precautions being taken to safeguard such account information. Often, he would have to agree that his account information could be released to qualified organizations or entities 102 to ensure that his checks 135 would not be converted in the future.

The check graphic may include the front and back of a returned check or an image replacement document (IRD). In this example, the check graphic is illustrated as a portion of an IRD, which would be considered a legal representation of the particular transaction. This transaction is associated with a MICR code, which is generated or manipulated at different points during transaction processing. For example, the first MICR code may be preprinted on the check prior to the actual transaction. In this example, the MICR code includes an item type indicator of “1,” a routing number or field 5 of “12345,” an account number of “12345678,” and a check number of “101.” The MICR code has been supplemented with the captured amount, “100.00,” perhaps at the receiving entity 102. The second or back portion of the IRD includes various processing, authorization, and deposit data. For example, the back of the check includes the financial institution of first deposit, namely “First National Bank.” The back of the check further describes the date of first deposit, item sequence number, and any endorsement, in this case a stamp of “For Deposit Only.”

It will be understood that the illustrated display 116 is for illustration purposes only. Display 116 may include some, all, or different features (not illustrated) without departing from the scope of this disclosure. Of course, a similar display could be used by receiving entity 102 to allow consumer 101 to directly enter opt-out data into an opt-out list local to such entity 102. Indeed, receiving entity 102 could, if appropriate, then transmit such a new local consumer record to opt-out provider 107, perhaps at predetermined times or occurrences for distribution to other receiving entities 102.

FIG. 4 is a flowchart illustrating an example method 400 for processing a conversion opt-out from a consumer in accordance with one embodiment of the present disclosure. For example, method 400 includes opt-out provider 107 presenting an interface to consumer 101 and updating opt-out list 140 as appropriate. The following description focuses on the operation of a particular opt-out management engine 130 in performing these methods. But system 100 contemplates using any appropriate combination and arrangement of logical elements implementing some or all of the described functionality.

Method 400 begins at step 402, where opt-out list provider 107 receives a request for opt-out page the client 109. As described above, the user of client 109 is typically a consumer 101. After receiving a request, opt-out management engine 130 authorizes client 109 at step 404. For example, opt-out management engine 130 may present a login page to consumer 101, request certain identifying information such as social security number and credit card number, or any other authentication. If opt-out management engine 130 does not authorize client 109 at decisional step 406, then processing ends. Otherwise, opt-out management engine 130 presents the opt-out page client 109 at step 408.

Once presented, opt-out management engine 130 generally receives the information 155 for updating the consumer opt-out list 140. For example, opt-out management engine 130 receives a client identifier at step 410. Such a client identifier may be the consumer's legal name, social security number, or any other identifier. Next, at step 412, opt-out management engine 130 receives a routing/transit number. At step 414, opt-out management engine 130 verifies the routing/transit number. For example, opt-out management engine 130 may compare the received routing/transit number to a local or distributed list of valid routing/transit numbers, verify that the routing/transit number allows opt outs, or execute any other verification technique. In certain embodiments, opt-out management engine 130 then presents the associated financial institution name to client 109 over the opt-out page at step 416. Once opt-out management engine 130 receives an account number at step 418, it authorizes the account number at step 420.

When appropriate opt-out information 155 is gathered, opt-out management engine 130 then identifies an opt-out list 140 at step 422. For example, opt-out management engine 130 may determine that the routing/transit number-account number combination identifies a particular regional opt-out list 140 as opposed to another regional opt-out list 140. In another example, opt-out management engine 130 may merely ensure that the appropriate or sole instance is available for updating. At step 424, opt-out management engine 130 assesses the identified list for a duplicate entry based on any appropriate key. If it is a duplicate, as showed at decisional step 426, then opt-out management engine 130 notifies client 109 of the duplicate at step 428 and processing ends. Otherwise, opt-out management engine 130 adds the received information to opt-out list 140 at step 430. The step of adding the new information may further include any suitable massaging of the data, information supplementation, or other data management. At step 432, opt-out management engine 130 updates the timestamp associated with master opt-out list 140, updates a counter of the number of records or number of updates, or performs any other suitable update processing. In certain circumstances, opt-out management engine 130 may then notify subscribers that an updated opt-out list 140 or update file 150 is available for download.

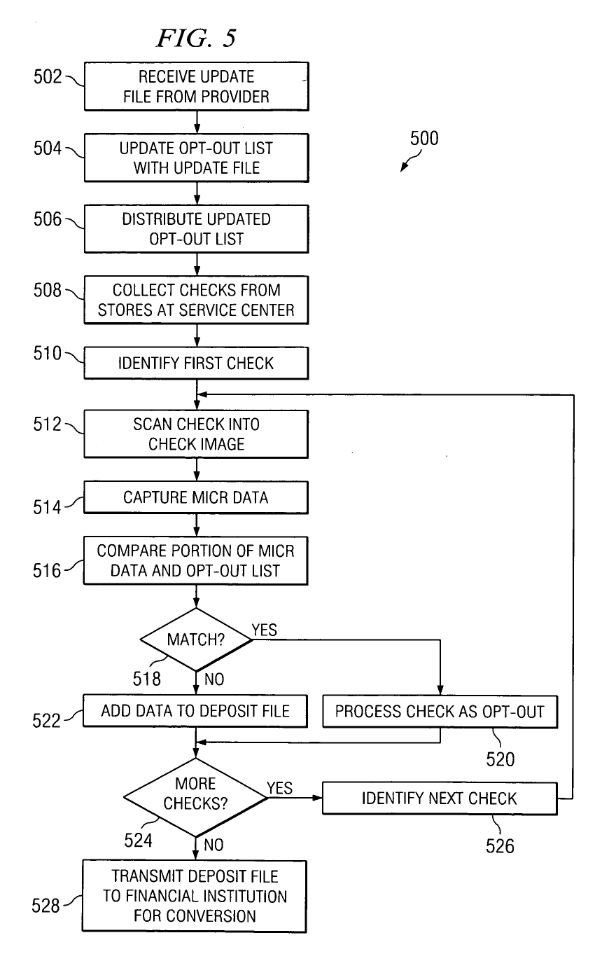

FIG. 5 is a flowchart illustrating an example method 500 for processing checks using the opt-out list in accordance with one embodiment of the present disclosure. At a high level, method 500 includes determining whether the consumer 101 associated with each particular check 135 has opted out of payment conversions and then processing the check 135 accordingly. Again system 100 contemplates using any appropriate combination and arrangement of logical elements implementing some or all of the described functionality. Indeed, while described as at least partially occurring at a retail level store, method 500 may be performed at any appropriate location such as, for example, at a mail processing center, a store, or other front or back office.

Method 500 begins at step 502, when receiving entity 102 receives an update file 150 from opt-out list provider 107. Receiving entity 102 updates its local opt-out list based on the received update file 150 at step 504. For example, the update file 150 may include new consumer records or a delta that are then added to the local opt-out list. In another example, the update file may comprise a complete updated (or more current) opt-out list 140 to replace the current local opt-out list. In yet another example, receiving entity 102 may be given the option of determining or requesting in what format to receive the update file 150 from opt-out list provider 107. In some cases, receiving entity 102 may then distribute the updated opt-out list to various points of receipt or stores 103 at step 506.

At some point, receiving entity 102 may collect checks 135 from stores 103 at a central or regional service center 104 as illustrated at step 508. Regardless of the particular location, receiving entity 102 then begins processing checks 135 for deposit at one or more financial institutions 106. For example, at step 510, receiving entity 102 identifies a first check 135. Next, in certain circumstances, receiving entity 102 scans check 135 into an electronic check image at step 512. Often, using scanner 124, receiving entity 102 then captures MICR data or other relevant check data at step 514. Using this captured data, receiving entity 102 compares the captured data to the local opt-out list at step 516. If there is a match at decisional step 518, then receiving entity 102 processes check 135 under certain opt-out procedures and the illustrated processing ends for this particular check. For example, this processing may include transporting the physical checks 135 to the appropriate financial institution 106, processing check 135 as an electronic check image, IRD, or other substitute check according to Check 21, or any other appropriate processing. But if the MICR data (or the relevant portion thereof) did not match a consumer record in the opt-out list, receiving entity 102 then performs any appropriate ARC or Back Office Conversion (BOC) processing. For example, such BOC processing may include adding data to an appropriate deposit file for subsequent electronic payment conversion at step 522. Next, receiving entity 102 determines if there are more checks 135 at decisional step 524. If there are, then receiving entity 102 identifies the next check 135 and processing returns to step 512. Once there are no more checks 135, then receiving entity 102 transmits the data file 160 to one or more financial institutions 106 for conversion to electronic payments 170, such as ACH.

The preceding flowcharts and accompanying descriptions illustrate exemplary methods 400 and 500. In short, system 100 contemplates using any suitable technique for performing these and other tasks. Accordingly, many of the steps in this flowchart may take place simultaneously and/or in different orders than as shown. Moreover, system 100 may use methods with additional steps, fewer steps, and/or different steps, so long as the methods remain appropriate. For example, receiving entity 102 may not include or store a local copy of the opt-out list, but may instead directly reference a master opt-out list 140 provided by or from opt-out list provider 107. In another example, receiving entity 102 may locally convert checks 135 to electronic payments, assuming no opt-out was requested, prior to transmission to any financial institution 106.

Although this disclosure has been described in terms of certain embodiments and generally associated methods, alterations, and permutations of these embodiments and methods will be apparent to those skilled in the art. For example, receiving entity 102 may process electronic checks, as well as physical checks and other commercial paper. Accordingly, the above description of example embodiments does not define or constrain this disclosure. Other changes, substitutions, and alterations are also possible without departing from the scope of this disclosure.

What is claimed is:

1. Software for consumer opt-out of payment conversions comprising computer readable instructions operable to:
identify check data of a physical check at a receiving entity;
compare the identified check data to an opt-out list to determine a match, the opt-out list comprising a plurality of consumer records and at least a subset of the consumer records provided by an opt-out list provider;
in response to the identified check data not being matched to the opt-out list, authorize the check for conversion to an electronic payment transaction; and
in response to the identified check data being a match to the opt-out list, indicate that the check should be processed by a financial institution without electronic payment conversion.

2. The software of claim 1, the electronic payment transaction comprising an Automated Clearing House (ACH) transaction.

3. The software of claim 2, wherein the software operable to compare the identified check data to an opt-out list comprises software operable to compare the identified check data to a local opt-out list and the software further operable to automatically download updates to the opt-out list from the opt-out list provider.

4. The software of claim 3 further operable to poll the opt-out list provider to identify updates for the local opt-out list.

5. The software of claim 3, the update comprising at least one consumer record added to an opt-out list located at the opt-out list provider from a remote computer via a browser.

6. The software of claim 1, the opt-out list provider comprising a nationwide opt-out list provider.

7. The software of claim 1, wherein the software operable to identify check data of a physical check at a receiving entity comprises software operable to capture at least a routing/transit number and an account number from a Magnetic Ink Character Recognition (MICR) line of the check and each consumer record in the opt-out list comprising at least a routing/transit number and an account number from an associated consumer account.

8. The software of claim 1, the check comprising a business check.

9. The software of claim 1, wherein the software operable to authorize the check for conversion to an electronic payment transaction comprises software operable to communicate the electronic payment transaction to an ACH network for processing via the financial institution.

10. The software of claim 1, wherein the software operable to indicate that the check should be processed by a financial institution without electronic payment conversion comprises software operable to:
present a message to an operator at the receiving entity; and
send an image replacement document (IRD) to the financial institution.

11. A method for consumer opt-out of payment conversions comprising:
identifying check data of a physical check at a receiving entity;
comparing the identified check data to an opt-out list to determine a match, the opt-out list comprising a plurality of consumer records and at least a subset of the consumer records provided by an opt-out list provider;
in response to the identified check data not being matched to the opt-out list, authorizing the check for conversion to an electronic payment transaction; and
in response to the identified check data being a match to the opt-out list, indicating that the check should be processed by a financial institution without electronic payment conversion.

12. The method of claim 11, the electronic payment transaction comprising an Automated Clearing House (ACH) transaction.

13. The method of claim 12, wherein comparing the identified check data to an opt-out list comprises comparing the identified check data to a local opt-out list and further comprising automatically downloading updates to the local opt-out list from the opt-out list provider.

14. The method of claim 13 further comprising polling the opt-out list provider to identify updates for the local opt-out list.

15. The method of claim 13, the update comprising at least one consumer record added to an opt-out list located at the opt-out list provider from a remote computer via a browser.

16. The method of claim 11, the opt-out list provider comprising a nationwide opt-out list provider.

17. The method of claim 11, wherein identifying check data of a physical check at a receiving entity comprises capturing at least a routing/transit number and an account number from a Magnetic Ink Character Recognition (MICR) line of the check and each consumer record in the opt-out list comprising at least a routing/transit number and an account number from an associated consumer account.

18. The method of claim 11, wherein authorizing the check for conversion to an electronic payment transaction comprises generating the electronic payment transaction to an ACH network for processing via the financial institution.

19. The method of claim 11, wherein indicating that the check should be processed by a financial institution without electronic payment conversion comprises:
presenting a message to an operator at the receiving entity; and
sending an image replacement document (IRD) to the financial institution.

20. A system for consumer opt-out of payment conversions residing comprising:
memory storing a local opt-out list; and
one or more processors operable to:
identify check data of a physical check;
compare the identified check data to the local opt-out list to determine a match, the opt-out list comprising a plurality of consumer records and at least a subset of the consumer records provided by an opt-out list provider;
in response to the identified check data not being matched to the opt-out list, authorize the check for conversion to an electronic payment transaction; and
in response to the identified check data being a match to the opt-out list, indicate that the check should be processed by a financial institution without electronic payment conversion.

21. The system of claim 20, the electronic payment transaction comprising an Automated Clearing House (ACH) transaction.

22. The system of claim 21, the one or more processors operable to compare the identified check data to an opt-out list comprises one or more processors operable to compare the identified check data to a local opt-out list and the one or more processors further operable to automatically download updates to the opt-out list from the opt-out list provider.

23. The system of claim 22, the update comprising at least one consumer record added to an opt-out list located at the opt-out list provider from a remote computer via a browser.

24. The system of claim 20, the opt-out list provider comprising a nationwide opt-out list provider.

25. The system of claim 20, wherein the one or more processors operable to identify check data of a physical check at a receiving entity comprises one or more processors operable to process at least a routing/transit number and an account number from a Magnetic Ink Character Recognition (MICR) line of the check captured by a scanner and each consumer record in the opt-out list comprising at least a routing/transit number and an account number from an associated consumer account.

26. The system of claim 20, wherein the system is resident at the financial institution.

27. The system of claim 20, wherein the one or more processors operable to indicate that the check should be processed by a financial institution without electronic payment conversion comprises one or more processors operable to:
present a message to an operator at the receiving entity; and
send an image replacement document (IRD) to the financial institution.

28. A method for updating a consumer opt-out list of payment conversions, comprising:
receiving a request to update a consumer opt-out list from a particular remote consumer via a network, the consumer opt-out list comprising a plurality of consumer records;
presenting an opt-out GUI to the particular consumer;
receiving information to generate a new consumer record via the GUI, the information comprising at least a financial institution identifier and an account identifier; and
updating the consumer opt-out list with the new consumer record based on the received information.

29. The method of claim 28, further comprising authenticating the user prior to updating the consumer opt-out list with the new consumer record based on the received information.

30. The method of claim 28, the opt-out list comprising a master opt-out list and the method further comprising:
identifying at least one of a plurality of subscribers; and
communicating an update file to the one or more identified subscribers.

31. The method of claim 30, the update file comprising a delta between the particular subscriber's local opt-out list and the master opt-out list.

32. The method of claim 30, wherein communicating the update file to the particular subscriber comprises communicating the update file to the subscriber based on one of the following:
a total number of consumer record updates since a last communicated update file to the subscriber; or
a time period since the last communicated update file to the subscriber.
